(19) United States
(12) Patent Application Publication
(10) Pub. No.: US 2022/0057248 A1
(43) Pub. Date: Feb. 24, 2022

(54) REFRIGERATOR

(71) Applicant: ROHM CO., LTD., Kyoto-shi (JP)

(72) Inventor: Hirotoshi USUI, Kyoto-shi (JP)

(21) Appl. No.: 17/520,928

(22) Filed: Nov. 8, 2021

Related U.S. Application Data
(63) Continuation of application No. PCT/JP2020/017545, filed on Apr. 23, 2020.

(30) Foreign Application Priority Data
May 9, 2019 (JP) 2019-089180

(51) Int. Cl. G01F 23/26; F25D 23/04; F25D 29/00

(52) U.S. Cl. CPC G01F 23/268; H04N 7/183; F25D 29/005; F25D 23/04

(57) ABSTRACT

A refrigerator includes a pocket that is capable of accommodating multiple liquid containers. The pocket includes a first sensor provided to an inner wall that is in contact with the side face of each of the multiple liquid containers. A detector detects the remaining amount of each liquid container that is in contact with the first sensor electrode based on the state of the first sensor electrode.

### CROSS REFERENCE TO RELATED APPLICATIONS

This application is a continuation under 35 U.S.C. § 120 of PCT/JP2020/017545, filed Apr. 23, 2020, which is incorporated herein reference and which claimed priority to Japanese Application No. 2019-089180, filed May 9, 2019. The present application likewise claims priority under 35 U.S.C. § 119 to Japanese Application No. 2019-089180, filed May 9, 2019, the entire content of which is also incorporated herein by reference.

### BACKGROUND

### 1. Technical Field

The present disclosure relates to a detection technique for detecting an amount of liquid remaining in a refrigerator.

### 2. Description of Related Art

As a sensor for detecting an amount of liquid, i.e., the level of liquid in a container or a tank, known examples of such a sensor include a float sensor and an optical sensor.

In recent years, development has been advanced for consumer electronics devices that support the Internet of Things (IoT). It is needless to say that storage units such as refrigerators are no exception. A refrigerator stores various kinds of liquids such as water, milk, juice, etc., in a state in which they are accommodated in respective specific containers.

In some cases, such a container is non-transparent. In this case, an optical sensor cannot be used. Also, such containers have different weights. Accordingly, it is difficult to estimate the remaining amount based on the weight.

### SUMMARY

The present disclosure has been made in view of such a situation.

Description will be made regarding an outline of several example embodiments of the present disclosure. In this outline, some concepts of one or more embodiments will be described in a simplified form as a prelude to the more detailed description that is presented later in order to provide a basic understanding of such embodiments. Accordingly, the outline is by no means intended to restrict the scope of the present invention or the present disclosure. Furthermore, this outline is not an extensive overview of all conceivable embodiments, and is by no means intended to restrict essential elements of the embodiments. For convenience, the term “one embodiment” may be used herein to refer to a single embodiment or multiple embodiments disclosed in the present specification.

A refrigerator according to one embodiment includes a pocket structured to be capable of accommodating multiple liquid containers, and including a first sensor electrode provided to an inner wall thereof that is in contact with side faces of the multiple liquid containers; and a detector structured to detect the remaining amount of the liquid container that is in contact with the first sensor electrode based on a state of the first sensor electrode.

With such an arrangement in which the electrostatic capacitance formed between the first sensor electrode and the liquid container is measured, this allows the remaining amount to be detected.

In one embodiment, the pocket may include: multiple cartridges each structured to be capable of accommodating a single liquid container; and a holder on which the multiple cartridges are detachably mounted. Also, the cartridges may each be provided with the first sensor electrode. This is capable of preventing the occurrence of position misalignment between the liquid container and the first sensor electrode, thereby allowing accurate detection of the remaining amount.

In one embodiment, the liquid container may have a standardized size. With such an arrangement in which the pocket is designed such that it conforms to a container having a standardized size, this allows misalignment to be prevented, thereby providing improved accuracy of the remaining amount detection. Also, the content of the liquid container may be milk.

In one embodiment, the pocket may be structured to be capable of accommodating the multiple liquid containers such that they are side-by-side in a first direction. Also, the multiple first sensor electrodes may be provided with intervals in the first direction.

In one embodiment, the pocket may further include an insulating partition plate positioned between adjacent liquid containers. Such a partition plate allows each liquid container to be fixed at a position such that it faces the corresponding first sensor electrode. Furthermore, such an arrangement is capable of preventing a single first sensor electrode from coming into contact with multiple liquid containers.

In one embodiment, the partition plate may be movable in the first direction. This allows the pocket to accommodate liquid containers having various sizes.

In one embodiment, the pocket may further include multiple second sensor electrodes provided to a surface thereof that is in contact with bottom faces of the liquid containers. This allows the presence or absence of the liquid container to be judged.

In one embodiment, the pocket may further include multiple third sensor electrodes closely arranged in the first direction at the same height on the inner wall. This allows the cross-sectional shape of the liquid container to be judged.

A refrigerator according to one embodiment includes: a pocket structured to be capable of accommodating multiple liquid containers, and including multiple sensor electrodes provided in a matrix to an inner wall thereof that is in contact with side faces of the multiple liquid containers; and a detector structured to detect remaining amounts and shapes of the multiple liquid containers based on states of the multiple sensor electrodes.

In one embodiment, the refrigerator may further include: a camera provided inside the refrigerator, so as to capture an image of the pocket; and a display provided to a door of the refrigerator, and structured to display the image captured by the camera.

In one embodiment, the display may be structured to display information that indicates the remaining amount for each of the liquid containers included in the image. This allows the user to know what the degree of the remaining amount is for which liquid container in an intuitive and visual manner without a need to open the refrigerator.

It should be noted that any combination of the components described above may be made, and a manifestation of the present invention may be mutually substituted between a method, apparatus, etc., which are also effective as an embodiment of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram showing the interior of a refrigerator according to an embodiment;

FIG. 2 is a diagram for explaining a structure of a pocket;

FIG. 3 is a diagram showing a principle of remaining amount detection;

FIG. 4A and FIG. 4B are diagrams each showing an example of the electrostatic capacitances formed at multiple sub-electrodes;

FIGS. 5A through FIG. 5C are diagrams each showing the pocket according to an example 1;

FIG. 6A is a plan view showing a pocket according to an example 2 as viewed from above, and FIG. 6B is a plan view showing a pocket without a partition plate as viewed from above;

FIG. 7 is a diagram showing a pocket according to an example 3;

FIG. 8 is a diagram showing a pocket according to an example 4;

FIG. 9A and FIG. 9B are plan views for explaining the function of the pocket shown in FIG. 8;

FIG. 10A and FIG. 10B are diagrams showing the electrostatic capacitances formed at multiple third electrodes measured in the state shown in FIG. 9A and FIG. 9B;

FIG. 11 is a diagram showing a pocket according to an example 5; and

FIG. 12 is a diagram showing a refrigerator according to a modification.

### DETAILED DESCRIPTION

Description will be made below regarding preferred embodiments with reference to the drawings. In each drawing, the same or similar components, members, and processes are denoted by the same reference numerals, and redundant description thereof will be omitted as appropriate. The embodiments have been described for exemplary purposes only, and are by no means intended to restrict the present invention. Also, it is not necessarily essential for the present invention that all the features or a combination thereof be provided as described in the embodiments.

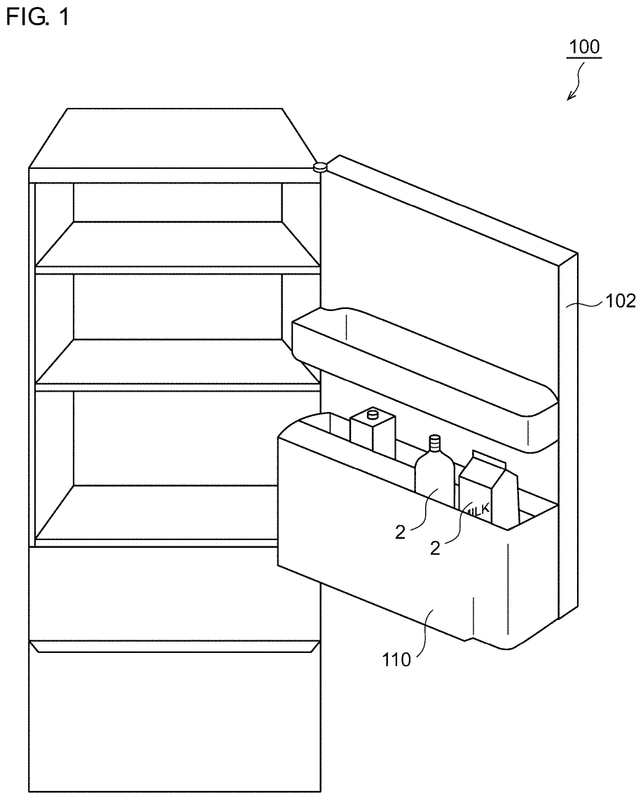

FIG. 1 is a diagram showing the interior of a refrigerator 100 according to an embodiment. The refrigerator 100 is provided with a pocket 110 that is capable of accommodating multiple liquid containers 2. The pocket 110 is provided to an inner side of a door 102, for example. However, the present invention is not restricted to such an arrangement. FIG. 1 shows an example in which the pocket 110 has a two-row configuration. Also, the pocket 110 may be provided as a single-row configuration. The refrigerator 100 is capable of detecting the remaining amount of each liquid container 2 accommodated in the pocket 110.

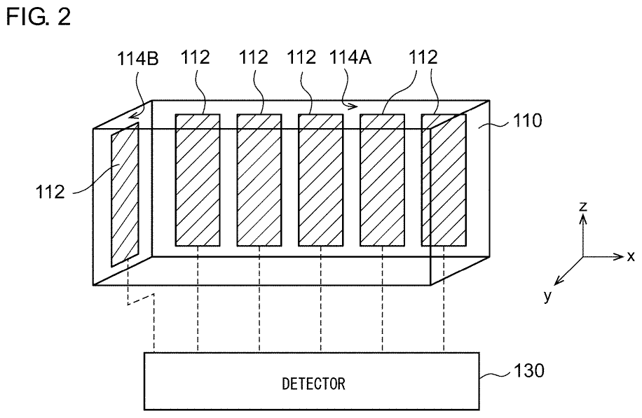

FIG. 2 is a diagram for explaining a structure of the pocket 110. The pocket 110 includes first sensor electrodes 112. Each first sensor electrode 112 is provided to an inner wall 114 of the pocket 110 that is in contact with the side face of each liquid container 2. Each first sensor electrode 112 may be provided in an exposed form, or may be embedded in the inner wall 114. The position of each first sensor electrode 112 is not restricted in particular. That is to say, each first sensor electrode 112 may preferably be arranged at a position that is in contact with a liquid container 2 for which the remaining amount is to be detected. Also, the number of the first sensor electrodes 112 is not restricted in particular. The multiple first sensor electrodes 112 are coupled to a detector 130. The detector 130 detects the electrostatic capacitances Cs formed between the multiple first sensor electrodes 112 and the liquid containers 2 to be detected. With this, the remaining amount of each liquid container 2 is acquired based on the electrostatic capacitance Cs formed at the corresponding first sensor electrode 112.

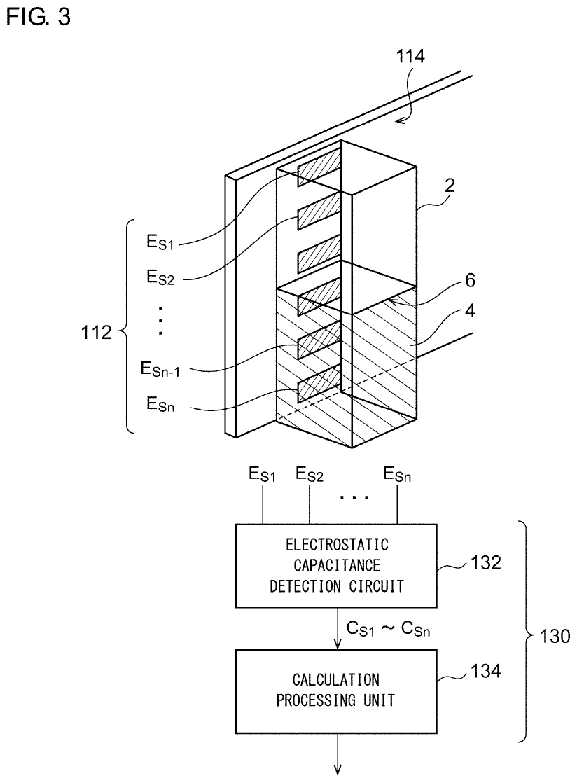

FIG. 3 is a diagram for explaining the principle of the remaining amount detection. For example, the first sensor electrode 112 includes multiple sub-electrodes Es1 through Esn arranged so as to be adjacent in the depth direction of the liquid container 2. The detector 130 includes an electrostatic capacitance detection circuit 132 and a calculation processing unit 134. The electrostatic capacitance detection circuit 132 is coupled to the multiple sub-electrodes Es1 through Esn, and is configured to be capable of detecting the electrostatic capacitance formed at each sub-electrode Es. Description will be made in this example with n=6. From among the multiple sub-electrodes Es1 through Esn, the sub-electrodes Esi (i=1, 2, 3) positioned above a liquid level 6 of a liquid 4 each exhibit a relatively small electrostatic capacitance Csi. In contrast, the sub-electrodes Esj (j=4 to 6) positioned below the liquid level 6 each exhibit a relatively large electrostatic capacitance Csj. The calculation processing unit 134 receives detection data that indicates the electrostatic capacitances Cs1 through Csn formed at the multiple sub-electrodes Es1 through Esn, and acquires the liquid level 6 based on the detection data.

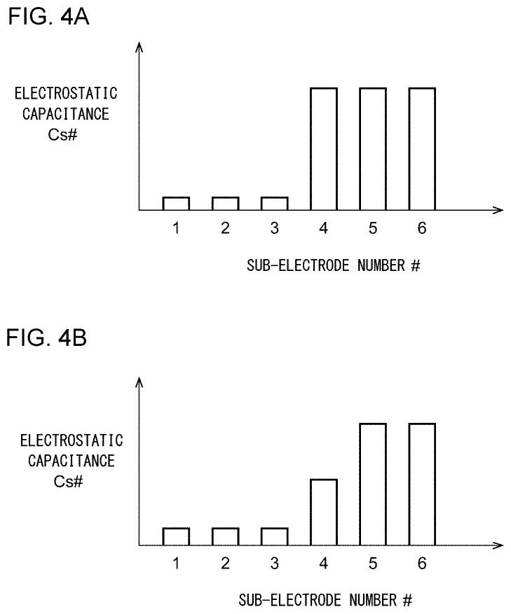

FIG. 4A and FIG. 4B are diagrams each showing an example of the electrostatic capacitances formed at the multiple sub-electrodes Es1 through Es6. In the example shown in FIG. 4A, the electrostatic capacitances Cs1 through Cs3 formed at the sub-electrodes Est through Es3 are relatively small. In contract, the electrostatic capacitances Cs4 through Cs6 formed at the sub-electrodes Es4 through Es6 are relatively large. Accordingly, as shown in FIG. 3, the calculation processing unit 134 is able to judge that the liquid level 6 is positioned between the third sub-electrode and the fourth sub-electrode.

In the example shown in FIG. 4B, the electrostatic capacitances Cs1 through Cs3 formed at the sub-electrodes Es1 through Es3 are relatively small. In contrast, the electrostatic capacitances Cs5 and Cs6 formed at the sub-electrodes Es5 and Es6 are relatively large. The electrostatic capacitance Cs4 formed at the fourth sub-electrode Es4 exhibits an intermediate value. In this case, the calculation processing unit 134 may judge that the liquid level 6 is positioned in a range of the fourth sub-electrode Es4. The calculation processing unit 134 may estimate the position in the range of the fourth sub-electrode Es4 in which the liquid level 6 exists, based on the value of the electrostatic capacitance Cs4.

The above is the configuration of the refrigerator 100. With the refrigerator 100 in which the first sensor electrodes 112 are provided to the inner wall 114 of the pocket 110 that is in contact with the liquid containers 2, and by measuring the electrostatic capacitances formed between the first sensor electrodes 112 and the liquid containers 2, this allows the remaining amount to be detected.

With the detection method for detecting the liquid level by means of the pocket 110 shown in FIG. 3, the liquid level 6, i.e., the remaining amount, is detected based on the relative relation between the electrostatic capacitances Cs1 through Csn formed at the multiple sub-electrodes Est through Esn. Accordingly, this allows the remaining amount to be accurately detected without being affected by the material of each liquid container 2 or the content of each liquid container 2.

It should be noted that the method for detecting the liquid level, the shape of each electrode, and the layout thereof, are not restricted to such an arrangement. Various kinds of known methods may be employed.

### Example 1

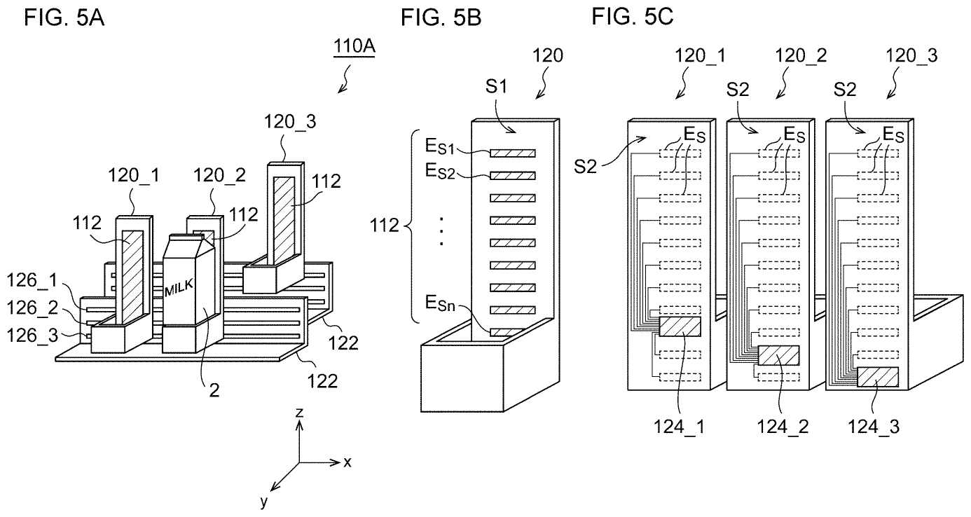

FIG. 5A through FIG. 5C are diagrams each showing a pocket 110A according to an example 1. As shown in FIG. 5A, the pocket 110A is provided with multiple cartridges 120 and a holder 122. Each cartridge 120 is configured to be capable of accommodating a single liquid container 2. The holder 122 is configured such that each cartridge 120 is detachably mounted on the holder 122 so as to allow each cartridge 120 to be moved.

Each cartridge 120 may preferably have a shape that conforms to the liquid container 2. For example, in a case in which the liquid container 2 is a milk carton, the liquid container 2 has a substantially standardized cross-sectional shape, and among such shapes, milk cartons having a 70 mm square cross-sectional shape have become mainstream. In some cases, milk cartons having a 57 mm square cross-sectional shape are also in distribution. From among the multiple cartridges 120, some cartridges 120 may be designed as dedicated cartridges for accommodating milk cartons. Also, PET bottles for storing water or soft drinks have approximately the same diameter or the same length on one side thereof. Accordingly, from among the cartridges 120, some cartridges 120 may each be designed as dedicated cartridges for PET bottles.

As shown in FIG. 5B, the first sensor 112 formed of multiple sub-electrodes Es is provided to a surface S1 of the cartridge 120 such that it faces the liquid container 2.

The detector 130 requires a power supply to operate. Accordingly, the detector 130 is preferably provided to the holder 122 or as an external component of the holder 122. In this case, each cartridge 120 is provided with the first sensor electrode 112 and an interface 124 that allows it to be coupled to the detector 130. As shown in FIG. 5C, the interface 124 may be provided to a surface S2 that is the opposite of that on which the first sensor 112 is provided.

As shown in FIG. 5A, the holder 122 includes multiple interfaces 126_1 through 126_3 arranged so as to be in contact with the interfaces 124_1 through 124_3 provided to the multiple cartridges 120.

As shown in FIG. 5C, the cartridges 120_1 through 120_3 respectively include the interfaces 124_1 through 124_3 formed at different heights. Furthermore, as shown in FIG. 5A, the interfaces 126_1 through 126_3 are provided at different heights so as to be in contact with the respective interfaces 124. In a case in which the multiple cartridges 120_1 through 120_3 are arranged in a first direction (x direction), the interfaces 126_1 through 126_3 are each formed in a rail structure that extends in the first direction. This allows the interface 124_i and the interface 126_i to be contact with each other regardless of the position at which the cartridge 120_i (i=1, 2, 3) is placed.

This allows the positions of the cartridges 120_1 through 120_3 to be swapped. It should be noted that the interface 124 may be provided to the bottom face of each cartridge 120. In this case, the position of the interface 126 on the holder 122 side may preferably be changed.

### Example 2

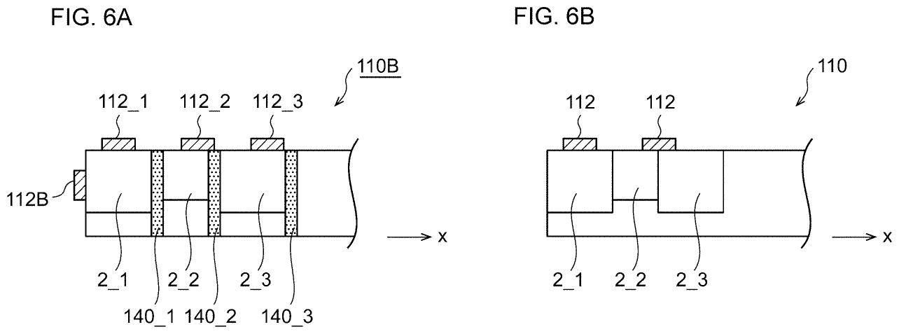

FIG. 6A is a plan view showing a pocket 110B according to an example 2 as viewed from above. Description has been made in the example 1 regarding the cartridge-type pocket. In contrast, the pocket 110B shown in FIG. 6A does not employ a cartridge. Instead, the pocket 110B is structured as a direct-type pocket that allows the liquid containers 2 to be directly accommodated. The pocket 110B is capable of accommodating the multiple liquid containers 2 such that they are side-by-side in the first direction (x direction in the drawing). The multiple first sensor electrodes 112 are arranged with intervals in the first direction. The pocket 110B is further provided with partition plates 140 each positioned between the adjacent liquid containers 2. Each partition plate 140 is arranged such that it can be moved in the first direction according to the size and position of the liquid container 2.

FIG. 6B is a diagram showing the pocket 110 without the partition plate 140. In a case in which the pocket 110 has no partition plate 140, this leads to a situation in which multiple liquid containers 2_2 and 2_3 come into contact with a single first sensor electrode 112 2 at the same time. In this case, the remaining amount detected based on the output of the first sensor electrode 112 2 will be unreliable. In addition, in a case in which the pocket 110 is provided on the inner side of the door as shown in FIG. 1, such an arrangement has a potential problem in that the positions of the liquid containers 2 may move when the door is opened or closed.

As shown in FIG. 6A, with such an arrangement in which the partition plates 140 are provided, such an arrangement is capable of avoiding a situation in which multiple liquid containers 2 come into contact with a single first sensor electrode 112. In addition, this is capable of preventing the liquid containers 2 from moving when the door is opened or closed.

As shown in FIG. 6A, the pocket 110B may include a first sensor electrode 112B provided to a surface thereof that is orthogonal to the x direction. When the partition plate 140_1 is moved toward the left side, this allows the liquid container 2_1 and the first sensor electrode 112B to be brought into close contact with each other without a gap. This allows the remaining amount of the liquid container 2_1 to be measured accurately. In a case in which the first sensor electrode 112B is provided, the first sensor electrode 112_1 may be omitted.

### Example 3

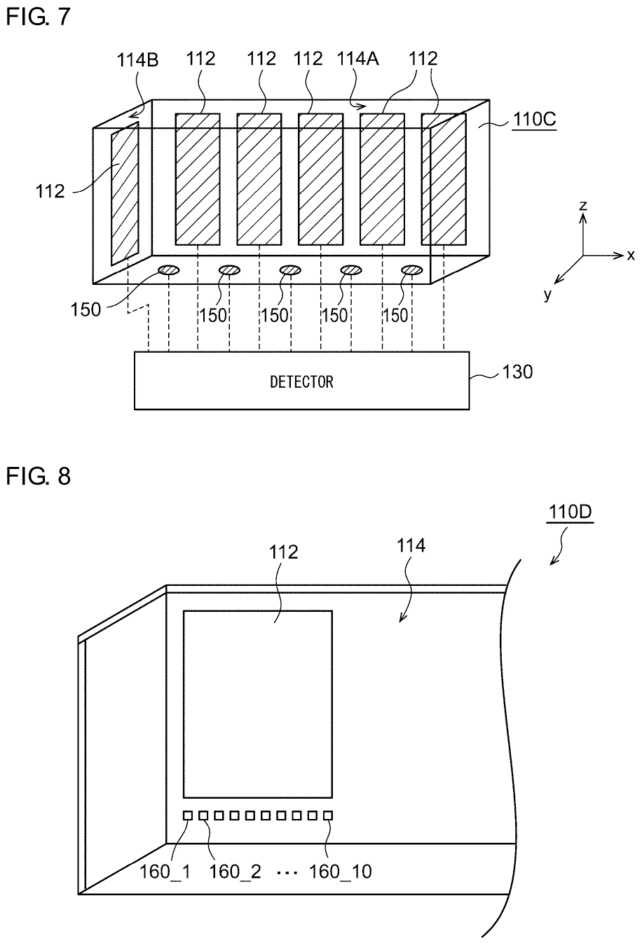

FIG. 7 is a diagram showing a pocket 110C according to an example 3. The pocket 110C shown in FIG. 7 is also configured as a direct-type pocket that does not employ a cartridge. The pocket 110C includes multiple second sensor electrodes 150 provided to a surface S3 thereof that is in contact with the liquid containers 2. The second sensor electrodes 150 may be arranged at the same positions in the x direction as those of the first sensor electrodes 112.

In addition to the plurality of first sensor electrodes 112, the detector 130 detects the electrostatic capacitances formed between the multiple second sensor electrodes 150 and unshown liquid containers. When the electrostatic capacitance formed at a second sensor electrode 150 is large, it can be assumed that there is a liquid container 2 on the second sensor electrode 150. When the electrostatic capacitance formed at a second sensor electrode 150 is small, it can be assumed that there is no liquid container 2.

It should be noted that the second sensor 150 may be provided to the bottom face of each cartridge described in the example 1 so as to judge the presence or absence of the liquid container for each cartridge.

### Example 4

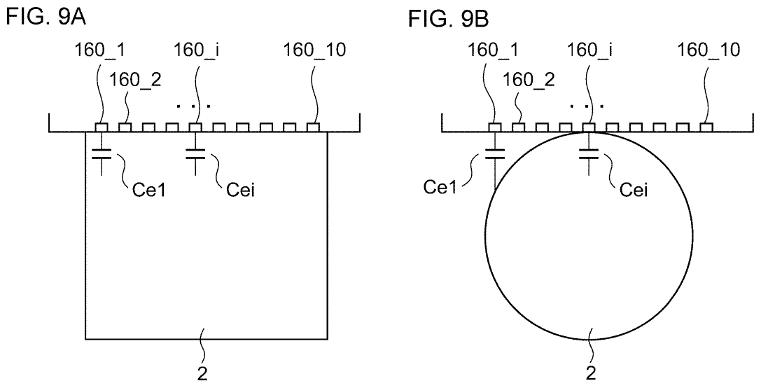

FIG. 8 is a diagram showing a pocket 110D according to an example 4. The pocket 110D shown in FIG. 8 is also configured as a direct-type pocket that does not employ a cartridge. Description will be made regarding the configuration of the pocket 110D configured to detect the cross-sectional shape of the liquid container 2. In addition to the first sensor electrodes 112, the pockets 110D includes multiple third electrodes 160_1 through 160_m (m=10 in FIG. 8) closely arranged on the inner wall 114 at the same height in the first direction (x direction). The detector 130 is capable of detecting the electrostatic capacitances (Ce1 through Cem shown in FIG. 9) formed at the multiple third electrodes 160_1 through 160_m.

FIG. 9A and FIG. 9B are plan views for explaining the function of the pocket 110D shown in FIG. 8. FIG. 9A shows a state in which the pocket 110D accommodates a liquid container 2 having a square cross-sectional shape. FIG. 9B shows a state in which the pocket 110D accommodates a liquid container 2 having a circular cross-sectional shape.

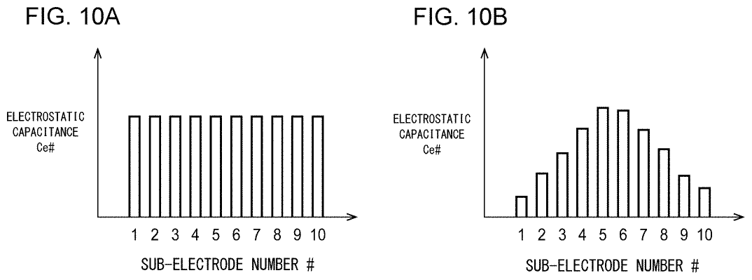

FIG. 10A and FIG. 10B are diagrams showing the electrostatic capacitances Ce1 through Ce10 formed at the multiple third electrodes 160 in the states shown in FIG. 9A and FIG. 9B. In a case in which the liquid container 2 has a rectangular cross-sectional shape, as shown in FIG. 10A, the electrostatic capacitances Ce1 through Ce10 are flat. In a case in which the liquid container 2 has a circular cross-sectional shape, as shown in FIG. 10B, the electrostatic capacitances Ce1 through Ce10 have a peak at a particular electrode position. The capacitance becomes smaller at a greater distance from the peak.

With the pocket 110D as described above, this allows the cross-sectional shape of the liquid container 2 to be measured.

It should be noted that the multiple third sensor electrodes 160 may be provided to the side face of each cartridge described in the example 1. This allows the shape of the liquid container to be measured for each cartridge.

### Example 5

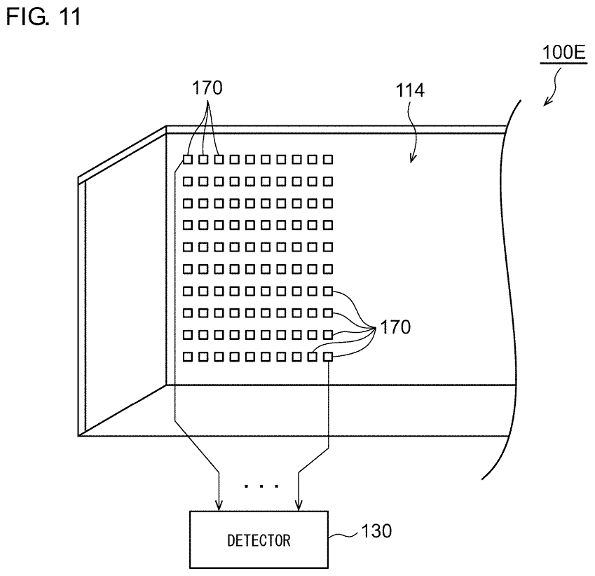

FIG. 11 is a diagram showing a pocket 110E according to an example 5. The pocket 110E shown in FIG. 11 is also configured as a direct-type pocket that does not employ a cartridge. The pocket 110E includes multiple sensor electrodes 170 arranged in a matrix on the inner wall 114 that is in contact with the side face of each of the multiple liquid containers 2. The sensor electrodes 170 have both the function of the first sensor electrodes 112 for detecting the remaining amount and the function of the third electrodes 160 for measuring the cross-sectional shape. The detector 130 detects the electrostatic capacitance formed between each of the multiple sensor electrodes 170 and the corresponding liquid container 2.

The detector 130 is capable of detecting the remaining amount and the shape for each of the multiple liquid containers 2 based on the states of the multiple sensor electrodes 170.

It should be noted that the multiple sensor electrodes 170 may be provided to each cartridge described in the example 1, and the remaining amount and the shape of the liquid container may be measured for each cartridge.

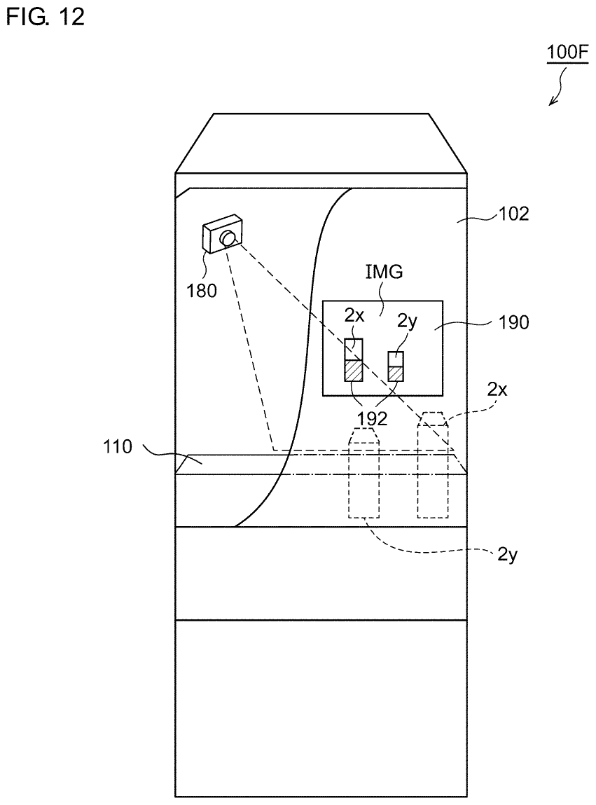

FIG. 12 is a diagram showing a refrigerator 100F according to a modification. The refrigerator 100F is provided with a camera 180 that captures an image of the pocket 110 arranged inside the refrigerator 100F. A display 190 is provided on the front side of the door 102 of the refrigerator 100F. The display 190 displays an image IMG captured by the camera 180.

The display 190 displays information that indicates the remaining amount for each of the liquid containers 2x and 2y included in the image IMG. The method of displaying the remaining amount is not restricted in particular. For example, as shown in FIG. 12, each remaining amount may be indicated in a graphical manner by means of an indicator 192 as shown by hatching.

This allows the user to know what the degree of the remaining amount is for which liquid container in an intuitive and visual manner without opening the door of the refrigerator 100F.

Description has been made regarding the present disclosure with reference to the embodiments using specific terms. However, the above-described embodiments show only an aspect of the mechanisms and applications of the present invention. Rather, various modifications and various changes in the layout can be made without departing from the spirit and scope of the present invention defined in appended claims.

1. A refrigerator comprising:
a pocket structured to be capable of accommodating a plurality of liquid containers, and comprising a first sensor electrode provided to an inner wall of the pocket that is in contact with side faces of the plurality of liquid containers; and
a detector structured to detect a remaining amount of the liquid container that is in contact with the first sensor electrode based on a state of the first sensor electrode.

2. The refrigerator according to claim 1, wherein the first sensor electrode comprises a plurality of sub-electrodes arranged so as to be adjacent in a depth direction of the liquid container.

3. The refrigerator according to claim 1, wherein the pocket comprises:
a plurality of cartridges each structured to be capable of accommodating a single liquid container; and
a holder on which the plurality of cartridges are detachably mounted,
and wherein the cartridges are each provided with the first sensor electrode.

4. The refrigerator according to claim 1, wherein the liquid container has a standardized size.

5. The refrigerator according to claim 4, wherein the content of the liquid container is milk.

6. The refrigerator according to claim 1, wherein the pocket is structured to be capable of accommodating the plurality of liquid containers such that they are side-by-side in a first direction,
and wherein a plurality of the first sensor electrodes are provided with intervals in the first direction.

7. The refrigerator according to claim 6, wherein the pocket further comprises an insulating partition plate positioned between adjacent liquid containers.

8. The refrigerator according to claim 7, wherein the partition plate is movable in the first direction.

9. The refrigerator according to claim 1, wherein the pocket further comprises a plurality of second sensor electrodes provided to a surface of the pocket that is in contact with bottom faces of the liquid containers.

10. The refrigerator according to claim 6, wherein the pocket further comprises a plurality of third sensor electrodes closely arranged in the first direction at the same height on the inner wall.

11. A refrigerator comprising:
a pocket structured to be capable of accommodating a plurality of liquid containers, and comprising a plurality of sensor electrodes provided in a matrix to an inner wall of the pocket that is in contact with side faces of the plurality of liquid containers; and
a detector structured to detect remaining amounts and shapes of the plurality of liquid containers based on states of the plurality of sensor electrodes.

12. The refrigerator according to claim 1, further comprising:
a camera provided inside the refrigerator, so as to capture an image of the pocket; and
a display provided to a door of the refrigerator, and structured to display the image captured by the camera.

13. The refrigerator according to claim 12, wherein the display is structured to display information that indicates a remaining amount for each of the liquid containers included in the image.
